(19) United States
(12) Patent Application Publication
(10) Pub. No.: US 2018/0322873 A1
(43) Pub. Date: Nov. 8, 2018

(54) SPEECH PROCESSING METHOD AND SPEECH PROCESSING DEVICE

(71) Applicant: SMARTISAN DIGITAL CO., LTD., Beijing (CN)

(72) Inventors: Yonghao Luo, Beijing (CN); Xiaomu Zhu, Beijing (CN); He Huang, Beijing (CN)

(21) Appl. No.: 15/971,347

(22) Filed: May 4, 2018

(30) Foreign Application Priority Data
May 8, 2017 (CN) 201710317737.X

(51) Int. Cl. G10L 15/22; G06F 3/0481; G06F 3/0482; G10L 15/26; G06F 3/16; G06F 17/30

(52) U.S. Cl. CPC G10L 15/22; G06F 3/04817; G06F 3/0482; G10L 2015/223; G06F 3/167; G06F 17/30696; G06F 17/30684; G10L 15/265

(57) ABSTRACT

A speech processing method and a speech processing device are provided. The method includes: collecting, in a case where it is detected that an operation on a designated key provided in the terminal meets a preset condition, a speech signal in an audio collecting region of the terminal, where the designated key is capable of being invoked at any interface of the terminal; converting the collected speech signal into a text; and displaying a text operating box on the display interface, and displaying the text in a text displaying region of the text operating box.

The present application claims priority to Chinese Patent Application No. 201710317737.X, titled “SPEECH PROCESSING METHOD AND SPEECH PROCESSING DEVICE”, filed on May 8, 2017 with the State Intellectual Property Office of People's Republic of China, which is incorporated herein by reference in its entirety.

### FIELD

The present disclosure relates to the technical field of data processing by a terminal, and in particular to a speech processing method and a speech processing device.

### BACKGROUND

In daily life and work, a user often has some idea or important information required to be recorded timely. At present, if the user has an idea or important information required to be recorded, it is required for the user to record the idea or important information in a paper document with a pen, or manually input the idea or important information into a text input region of a note application or other applications in a terminal. However, in many cases, the user may not have a paper or a pen at hand to timely record information suddenly occurred in mind, and a speed for manually recording with a pen is slow, which may affect timeliness of information recording, resulting in forgetting of the information due to a delayed record. However, in a case where the information required to be recorded is inputted into the text input region of the note application or other applications of the terminal, it is required for the user to find a corresponding application in the terminal and activate the application, then enter a corresponding interface in the application before inputting the information, resulting in a high complexity, thereby affecting timeliness of information recording. In addition, a limited speed of manual input by the user also affect the timeliness of information recording, resulting in forgetting of certain information, thus affecting integrity of the recorded information.

### SUMMARY

In view of the above, a speech processing method and a speech processing device are provided according to the present disclosure, to improve timeliness and convenience of information recording.

A speech processing method for a terminal having a display interface is provided according to an aspect of the present disclosure. The speech processing method includes: collecting, in a case where it is detected that an operation on a designated key provided in the terminal meets a preset condition, a speech signal in an audio collecting region of the terminal, where the designated key is capable of being invoked at any interface of the terminal; converting the collected speech signal into a text; and displaying a text operating box on the display interface, and displaying the text in a text displaying region of the text operating box.

In one embodiment, before displaying the text operating box on the display interface, the speech processing method further includes: searching for content related to the text. While displaying the text operating box on the display interface and displaying the text in the text displaying region of the text operating box, the speech processing method further includes: displaying a search result for the text on the display interface.

In one embodiment, the searching for the content related to the text includes: invoking at least one designated application in the terminal to search for the content related to the text.

In one embodiment, the invoking at least one designated application to search for the content related to the text includes one or more of: invoking a search engine in the terminal to search for the content related to the text; and invoking a contact list application in the terminal to search a contact list for the content related to the text.

In one embodiment, the searching for the content related to the text includes: searching applications installed in the terminal for a target application with an application name matching with the text. The displaying a search result for the text on the display interface includes: displaying, in a case where the target application is found, an icon of the target application in the display interface.

In one embodiment, after displaying the icon of the target application in the display interface, the speech processing method further includes: activating the target application in a case that it is detected that the icon of the target application displayed in the display interface is clicked.

In one embodiment, a sharing operation option for triggering sharing of the text is further displayed in the text operating box. After displaying the text in the text displaying region of the text operating box, the speech processing method further includes: displaying a sharable list in a case where a triggering operation on the sharing operation option is detected, where the sharable list includes multiple sharing manner options; and determining, in a case where a selecting operation on an sharing manner option in the sharable list is detected, a target sharing manner selected by the selecting operation, and transmitting a sharing instruction containing the text to a target application associated with the target sharing manner, where the sharing instruction is configured to instruct the target application to paste, based on the target sharing manner, the text into a region designated by the target sharing manner.

In one embodiment, after displaying the text in the text displaying region of the text operating box, the speech processing method further includes: displaying, in a case where an operation instruction for activating a text editing application for editing a text is detected, a text editing interface of the text editing application, where the text editing interface includes at least one text editing region; and determining, in a case where a designated drag operation on the text operating box is detected, a target text editing region where an ending point of the designated drag operation is located from the at least one text editing region of the text editing interface, and copying the text in the text operating box into the target text editing region, where the designated drag operation is used to drag the text operating box or the text in the text operating box to the text editing region.

In one embodiment, a contraction operation option for triggering contraction of the text operating box is further displayed in the text operating box. After displaying the text in the text displaying region of the text operating box, the speech processing method further includes: hiding the text operating box in a case where a trigger operation on the contraction operation option is detected; and displaying, in a case where a trigger operation on an expanding operation option for triggering display of the text operating box is detected when the text operating box is in a hidden state, the text operating box in the display interface.

In one embodiment, the displaying the text operating box on the display interface includes: displaying the text operating box on a top layer of the display interface.

In one embodiment, the designated key is a designated physical key. Before collecting the speech signal in the audio collecting region of the terminal, the speech processing method further includes: determining a current state of the terminal. In a case where the terminal is in an operating state, the operation for collecting the speech signal in the audio collecting region of the terminal is performed. In a case where the terminal is in a lock screen state or a standby state, the terminal is unlocked or awaked, and the operation for collecting the speech signal in the audio collecting region of the terminal is performed.

A speech processing device is further provided according to another aspect of the present disclosure. The speech processing device includes a speech collecting unit, a text converting unit and a text displaying unit. The speech collecting unit is configured to collect a speech signal in an audio collecting region of the terminal in a case where it is detected that an operation on a designated key provided in a terminal meets a preset condition. The designated key is capable of being invoked at any interface of the terminal. The text converting unit is configured to convert the collected speech signal into a text. The text displaying unit is configured to display a text operating box on a display interface and display the text in a text displaying region of the text operating box.

In one embodiment, the speech processing device further includes a text searching unit and a search result displaying unit. The text searching unit is configured to search for content related to the text before the text operating box is displayed on the display interface by the text displaying unit. The search result displaying unit is configured to display a search result for the text on the display interface while the text operating box is displayed on the display interface by the text displaying unit.

In one embodiment, the text searching unit includes a first text searching unit configured to invoke at least one designated application in the terminal to search for the content related to the text.

In one embodiment, the text searching unit includes a second text searching unit configured to search applications installed in the terminal for a target application with an application name matching with the text. The search result displaying unit is configured to display, in a case where the target application is found, an icon of the target application in the display interface while the text operating box is displayed on the display interface by the text displaying unit.

In one embodiment, a sharing operation option for triggering sharing of the text is further displayed in the text operating box displayed by the text displaying unit. The speech processing device further includes a list displaying unit and a text sharing unit. The list displaying unit is configured to display a sharable list in a case where a triggering operation on the sharing operation option is detected after the text is displayed in the text displaying region of the text operating box by the text displaying unit, where the sharable list includes multiple sharing manner options. The text sharing unit is configured to determine a target sharing manner selected by the selecting operation in a case where a selecting operation on an sharing manner option in the sharable list is detected, and transmit a sharing instruction containing the text to a target application associated with the target sharing manner, where the sharing instruction is configured to instruct the target application to paste, based on the target sharing manner, the text into a region designated by the target sharing manner.

In one embodiment, the speech processing device further includes an editing interface displaying unit and a text pasting unit. The editing interface displaying unit is configured to display, in a case where an operation instruction for activating a text editing application for editing a text is detected after the text is displayed in the text displaying region of the text operating box by the text displaying unit, a text editing interface of the text editing application, where the text editing interface includes at least one text editing region. The text pasting unit is configured to determine, in a case where a designated drag operation on the text operating box is detected, a target text editing region where an ending point of the designated drag operation is located from the at least one text editing region of the text editing interface, and copy the text in the text operating box into the target text editing region, where the designated drag operation is used to drag the text operating box or the text in the text operating box to the text editing region.

As can be seen from the above technical solution, since the designated key is capable of being invoked at any interface of the terminal, the terminal is triggered by performing the operation meeting the preset condition on the designated key regardless of an interface state of the terminal, to convert the inputted speech signal into a text and display the text in the text operating box of the display interface. In this way, if the user wants to record a certain idea or important information, it is only required to operate the designated key in the terminal and input a speech related to the idea or important information to the terminal, such that the idea or important information is recorded timely, thereby avoiding complex operations such as inputting and application lookup, thus improving the timeliness and convenience of information recording.

### BRIEF DESCRIPTION OF THE DRAWINGS

In order to more clearly describe the technical solution in the embodiments of the present disclosure, drawings to be used in the embodiments of the present disclosure are briefly described hereinafter. It is apparent that the drawings described below show merely the embodiments of the present disclosure, and those skilled in the art may obtain other drawings according to the provided drawings without any creative effort.

FIG. 1 is a schematic structural diagram of a terminal to which a speech processing method according to the present disclosure may be applied;

FIG. 2 is a schematic flow chart of a speech processing method according an embodiment of the present disclosure;

FIG. 3 is schematic diagram of a text operating box according to the present disclosure;

FIG. 4 is a schematic flow chart of a speech processing method according to another embodiment of the present disclosure;

FIG. 5 is a schematic diagram of a result page for converting a speech signal into a text according to the present disclosure;

FIG. 6 is a schematic flowchart of the speech processing method according to another embodiment of the present disclosure;

FIG. 7 is a schematic diagram of a displayed list of sharing manners related to a text operating box;

FIG. 8 is a schematic diagram of a display interface on which a contracted text operating box and a normally displayed text operating box are simultaneously displayed;

FIG. 9a and FIG. 9b respectively show a schematic impression diagram of dragging a text operating box in a note and a schematic impression diagram of pasting a text in a text operating box into the note; and

FIG. 10 is a schematic structural diagram of a speech processing device according to an embodiment of the present disclosure.

### DETAILED DESCRIPTION OF EMBODIMENTS

A speech processing method and a speech processing device are provided according to the embodiments of the present disclosure, which may be applied to any terminal, for example, a mobile terminal such as a mobile phone or a tablet computer, as well as a desktop computer. Considering flexibility and convenience of mobility of a mobile terminal, the embodiments in which the speech processing method and the speech processing device are applied to the mobile terminal are preferred in the present disclosure.

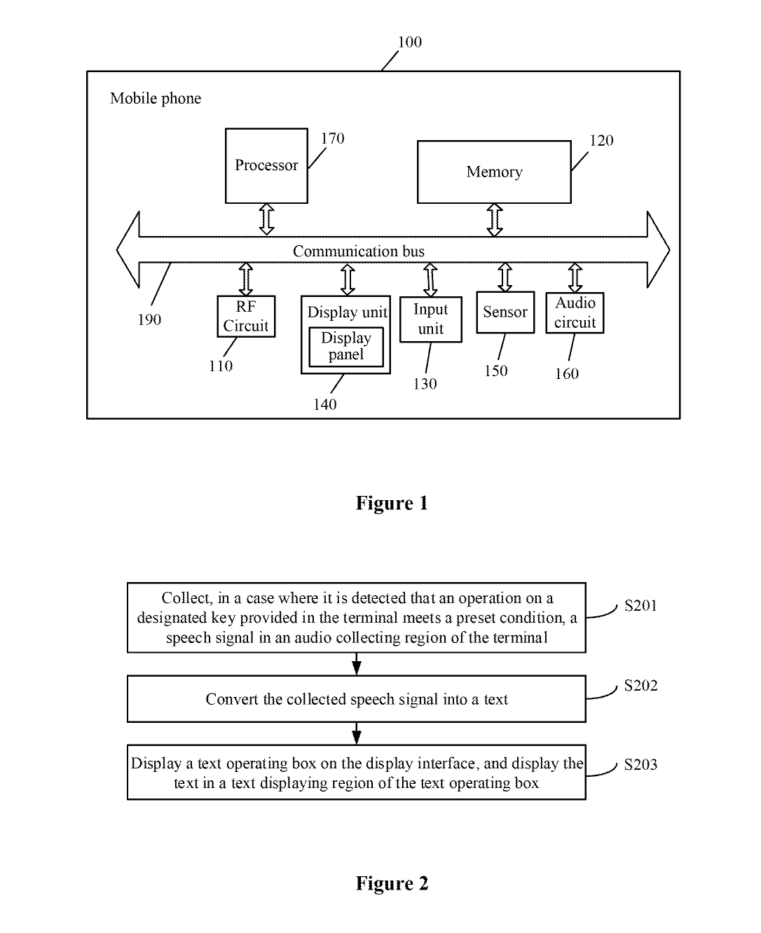

A mobile phone is described as an example of the terminal, as shown in FIG. 1, which is a schematic structural diagram of a part of a mobile phone 100 according to an embodiment of the present disclosure.

Referring to FIG. 1, the mobile phone 100 includes components such as a radio frequency (RF) circuit 110, a memory 120, an input unit 130, a display unit 140, a sensor 150, an audio circuit 160 and a processor 170. The RF circuit 110, the memory 120, the input unit 130, the display unit 140, the sensor 150, the audio circuit 160 and the processor 170 are connected via a communication bus 190.

It is to be understood by those skilled in the art that the structure of the mobile phone shown in FIG. 1 is not intended to limit the mobile phones, and may include more or less components than the illustrated components. Alternatively, some of the illustrated components may be combined, or an arrangement of components different from the arrangement shown in FIG. 1 may be adopted.

The components of the mobile phone 100 are described in detail with reference to FIG. 1 hereinafter.

The RF circuit 110 may be configured to transmit and receive information, or receive and transmit signals during a call. For example, a speech call or a communication with another mobile phone or terminal may be implemented based on the RF circuit.

The memory 120 may be configured to store software programs and modules. For example, the memory may store software program data such as a speech converting program related to the present disclosure as well as data such as a speech signal and a text converted from the speech signal. The memory 120 may be a high-speed random access memory, a non-volatile memory such as at least one of a disk storage device and a flash memory device, or other volatile solid-state storage devices.

The input unit 130 may be configured to receive inputted information of numeric or characters and generate a signal input of a key related to a user setting and function control of the mobile phone 100. Specifically, the input unit 130 may include a touch panel and other input devices. The touch panel, which is also referred to as a touch screen, may collect a touch operation of the user on or near the touch panel and drive a corresponding connection device based on a preset program. In addition to the touch panel, the input unit 130 may further include other input devices. Specifically, the other input devices may include, but not limited to, one or more of a physical keyboard, a function key (such as a volume control press key, a switch press key, a return key), a trackball, a mouse, a joystick and the like.

The display unit 140 may be configured to display information inputted by a user or information on outputted image and text. The display unit 140 may include a display panel. Further, the touch panel may cover the display panel. In a case where the touch panel detects a touch operation on or near the touch panel, the touch panel transmits the touch operation to the processor 170 to determine a type of the touch event. The processor 170 displays a corresponding visual output on the display panel based on the type of the touch event. Although the touch panel and the display panel function as two separate components to implement the input function and the output function of the mobile phone 100 in FIG. 1, the touch panel and the display panel may be integrated in some embodiments to implement the input function and the output function of the mobile phone 100.

The mobile phone 100 may further include at least one sensor 150 such as a light sensor, a motion sensor and other sensors.

The audio circuit 160 may be connected with a speaker and a microphone to provide an audio interface between the user and the mobile phone 100. The audio circuit 160 may transmit an electric signal converted from received audio data to the speaker, the speaker converts the electric signal into a sound signal and output the sound signal. On the other hand, the microphone converts a collected speech signal into an electric signal, the audio circuit 160 receives the electric signal, converts the electric signal into audio data and transmits the audio data to the RF circuit 110 for transmission to, for example, another mobile phone, or transmits the audio data to the memory 120 for a further processing.

The processor 170, which is a control center of the mobile phone 100, connects various components of the entire mobile phone through various interfaces and lines, and performs various functions of the mobile phone 100 and processes data by running or executing software programs and/or modules stored in the memory 120 and invoking data stored in the memory 120, so as to totally monitor the mobile phone.

In the embodiment of the present disclosure, the processor may be configured at least to: control, in a case where it is detected that an operation on a designated key provided in the terminal meets a preset condition, the audio circuit to collect a speech signal in an audio collecting region of the terminal, where the designated key is capable of being invoked at any interface of the terminal; converting the collected speech signal into a text; and control the display unit to display a text operating box on the display interface, and to display the text in the text displaying region of the text operating box.

Although not shown, the mobile phone 100 may further include a positioning module such as a GPS chip, a camera, a Bluetooth module and the like, which is not described here.

It should be noted that the above merely describes an example in which the terminal is a mobile phone, it should be understood that, in a case where the terminal is another mobile terminal or smart device, a composition of the terminal may be similar to that of the mobile phone, and details are not described herein.

A speech processing method according to the present disclosure is described below in conjunction with the above common features.

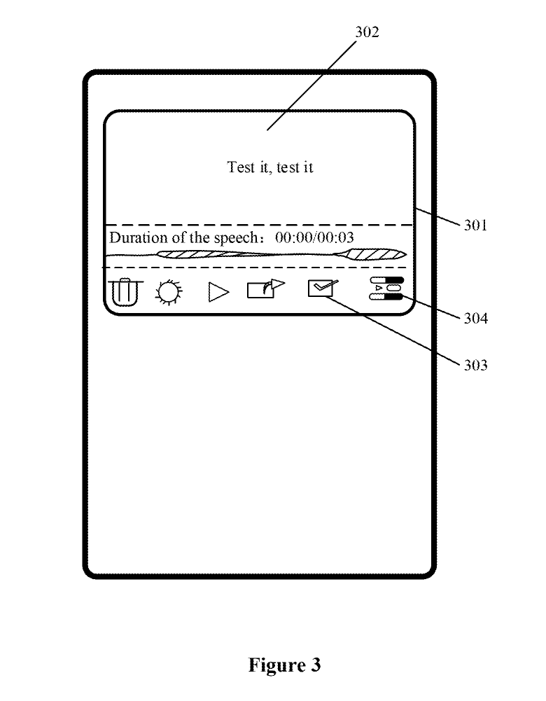

For example, reference is made to FIG. 2, which is a schematic flowchart of a speech processing method according an embodiment of to the present disclosure. The method according to the embodiment is performed by an operating system of a terminal which has a display interface. The method according to the embodiment may include the following steps S201 to S203.

In step S201, a speech signal in an audio collecting region of the terminal is collected in a case where it is detected that an operation on a designated key provided in the terminal meets a preset condition.

The designated key is capable of being invoked at any interface of the terminal. The designated key, which may be considered as a general key of the terminal, is different from function keys provided in an application in the terminal. Therefore, the designated key may be invoked and operated in an interface of any application or in a main interface of the terminal during the terminal operates any application. For example, the designated key may be a general key in the terminal such as a desktop key (which is commonly referred to as a home key), a back key and a menu key.

It should be understood that, in order to conveniently trigger collection of the speech signal regardless of the state of the terminal, the designated key may be a physical key provided in the terminal. For example, in a case where the home key provided in the terminal is a physical key, the home key may be used as the designated key. In this case, before the speech signal around the terminal is collected, a current state of the terminal may be determined. If the terminal is in an operating state, the audio circuit may be directly activated to collect the speech signal around the terminal; if the terminal is in a lock screen state or a standby state, the terminal may automatically perform unlocking or awake the screen (that is, awake the terminal, such that the terminal turns into the operating state) with skipping operations that the user manually unlock the terminal and awake the screen, then automatically activate the audio circuit, to collect the speech signals in the audio collecting region.

It can be seen that, in a case where the designated key is a physical key, even though the terminal is in the lock screen state or the standby state, the user may still trigger the terminal to activate a speech collection function by performing the operation meeting the preset condition on the designated key, and timely collect the speech signal inputted to the terminal.

The preset condition may be set as needed, as long as an operation meeting the preset condition can be distinguished from a conventional operation on a key in the current terminal.

For example, the preset condition may be that a duration of pressing the designated key exceeds a preset duration, for example, may be that a duration of pressing the home key exceeds the preset duration. In this case, as long as the preset condition is met, the audio circuit of the terminal may be activated to collect the speech signal inputted to the terminal until no speech signal is collected within a designated duration.

For example, the preset condition may be that the duration of pressing the designated key exceeds the preset duration and the designated key is still pressed currently, that is, only in a case where the duration of pressing the designated key exceeds the preset duration and the designated key is still pressed currently, the audio collection circuit collects the speech signal around the terminal. In this case, if the user stops pressing the designated key, the terminal terminates the collection of the speech signals around the terminal, and finally completes a process of converting the speech to a text.

The audio collecting region of the terminal may be a region around the terminal where the speech signal may be collected. A range of the audio collecting region is related to a range of the audio circuit in the terminal for collecting the audio signal.

It should be noted that in the embodiment of the present disclosure, the speech signal may be inputted to the terminal by a user of the terminal. For example, if the user suddenly thinks of some important ideas or important information, the user may record the idea or information into the terminal via speeches, such that the speech corresponding to the idea or important information of the user is recorded timely by the terminal, therefore, the idea or important information of the user is recorded in a text form for related processes. The speech signal may also be a speech signal outputted by the terminal, for example, a speech signal received and outputted by the terminal during the user performs a speech call with another terminal using the terminal, or a speech signal broadcasted during the user listening to a program using the terminal.

In step S202, the collected speech signal is converted into a text.

The text may include at least one character, which may be, for example, a Chinese character, an English character, a numeral and the like.

It should be understood that, after all the speech signals are collected in step S201, the speech signals may be converted into a text. In order to improve timeliness of the text conversion, in a process of collecting the speech signals, the currently collected speech signal may be converted into the text synchronously.

In step S203, a text operating box is displayed on a display interface, and the text is displayed in a text displaying region of the text operating box.

The text operating box includes a text displaying region. The text converted from the collected speech signal may be displayed in the text displaying region.

In one embodiment, some labeling options, for example, a frame that may be set into a selected state, may be provided in the text operating box, such that in a case where multiple text operating boxes are generated by the terminal, the user may label a text operating box including a text in which the user is interested or a text operating box that is already processed or a text operating box required to be processed as needed.

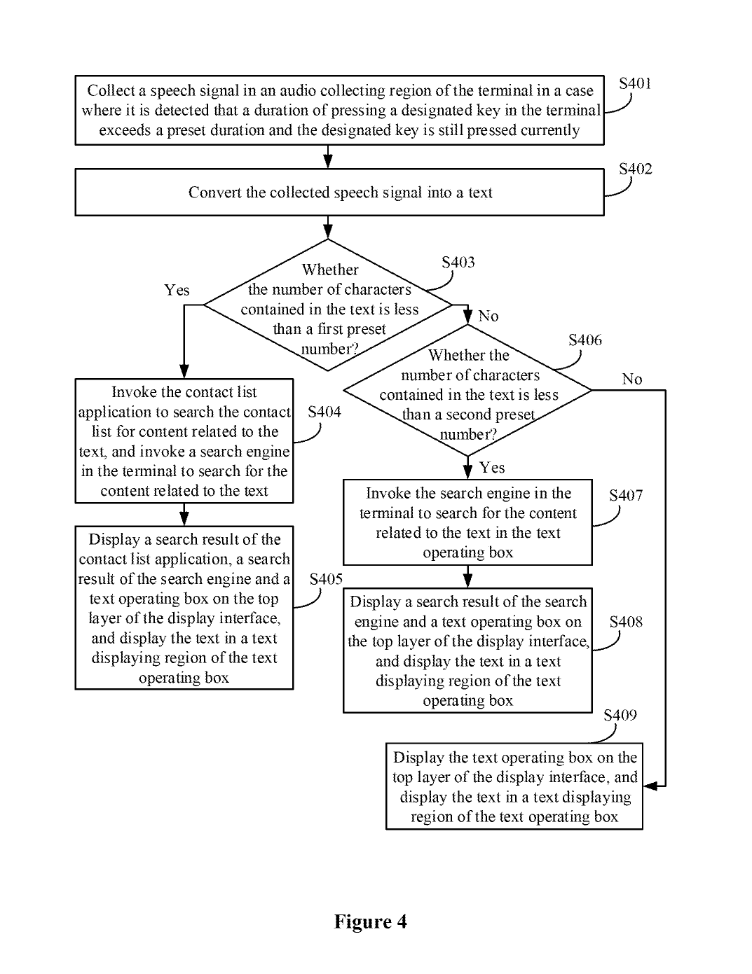

Reference is made to FIG. 3, which is a schematic diagram of a text operating box displayed in the display interface. As can be seen from FIG. 3, the text operating box 301 includes a text displaying region 302 in which a text “Test it, test it” is displayed. In addition, multiple operation options are provided on the bottom side of the text operating box, the operation options include a labeling option 303. In FIG. 3, the labeling option in the text operating box is in the selected state.

It should be understood that, in order to enable the user to timely and intuitively get information on the text converted from the speech signal inputted to the terminal, the text operating box may be displayed on a top layer of the display interface, such that the text operating box is not shaded by an interface of another application.

It can be seen that in the embodiment of the present disclosure, since the designated key is capable of being invoked at any interface of the terminal, the terminal is triggered by performing the operation meeting the preset condition on the designated key regardless of the display interface of the terminal, to convert the inputted speech signal to a text and display the text in the text operating box of the display interface. In this way, if the user wants to record a certain idea or important information, it is only required to operate the designated key in the terminal and input a speech related to the idea or the important information to the terminal, such that the idea or the important information is record timely, thereby avoiding complex operations such as inputting and application lookup, thus improving timeliness and convenience of information recording.

In addition, after the terminal converts the speech signal corresponding to some information in which the user is interested into the text, it is convenient for the user to perform some related operations based on the text. For example, the user performs searching based on the text, so as to further get the information in which the user is interested in detail. For example, the user searches for information related to the text by copying the text into a search engine. For example, the user stores the text as a memo or shares the text, thereby avoiding complexity for the user to perform related operations after manually inputting the text.

In order to further improve the convenience for the user to perform related operations based on the text in the text input box, several related operations performed based on the text are described hereinafter.

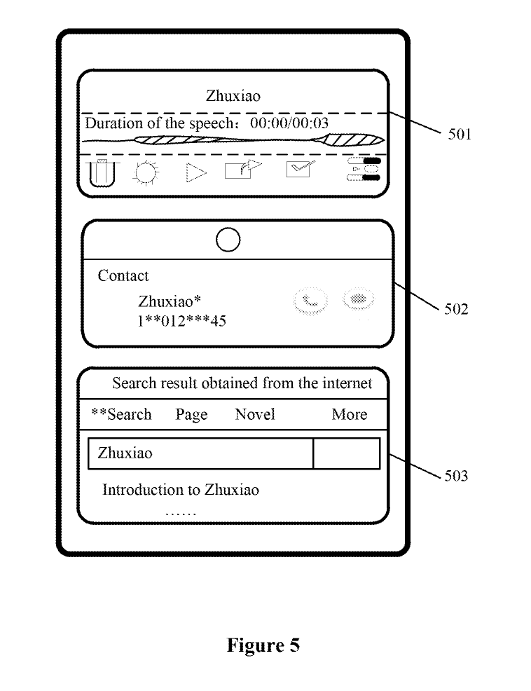

For example, reference is made to FIG. 4, which is a schematic flowchart of a speech signal processing method according to another embodiment of the present disclosure. The method according to the embodiment may include the following steps S401 to S409.

In step S401, a speech signal in an audio collecting region of the terminal is collected in a case where it is detected that a duration of pressing a designated key in the terminal exceeds a preset duration and the designated key is still pressed currently.

The designated key is capable of being invoked at any interface of the terminal.

In step S402, the collected speech signal is converted into a text.

It should be noted that, in order to facilitate the understanding of the solution of the present disclosure, the present embodiment is described by taking a preset condition as an example. However, other preset conditions are also applicable to this embodiment. Accordingly, a case where the text operating box is displayed on a top layer of the display interface is described as an example, but other cases are also applicable to the present embodiment, which are not limited herein.

In addition, for the specific implementation of the above steps, reference may be made to the related description in the above embodiments, and details are not described herein again.

In step S403, it is detected whether the number of characters contained in the text is less than a first preset number. If the number of the characters contained in the text is less than the first preset number, step S404 is performed. If the number of the characters contained in the text is not less than the first preset number, step S406 is performed.

The first preset number may be set as needed, for example, the first preset number may be 5 or 10.

It should be understood that the number of the characters contained in the text converted from the speech signal may provide a basis for the user to perform the related operation. For example, in a case where the text contains fewer characters, the user may search locally on the terminal for content related to the text. For example, the user may search for an application related to the text in the terminal; or the user may search for a contact corresponding to the text in the contact list, so as to perform a short message or communication interaction with the contact for some important matters subsequently. For example, the user may want to search for introduction information related to the text through a search engine so as to timely get the information related to the text.

Considering that the number of the characters contained in the text is related to a duration for inputting the collected speech signal, for example, more information contained in the speech signal leads to a long duration for inputting the speech signal, and further to a large number of characters contained in the converted text. Therefore, it may also be determined whether the total duration for inputting the collected speech signal is smaller than a first preset duration, which may be, for example, 5 seconds. If the total duration for inputting the collected speech signal is smaller than the first preset duration, step S404 is performed; if the total duration for inputting the collected speech signal is not smaller than the first preset duration, step S406 is performed.

Step S403 may be performed after all the inputted speech signals are converted into the text.

In step S404, the contact list application in the terminal is invoked to search the contact list for content related to the text, and a search engine in the terminal is invoked to search for the content related to the text.

If a contact in the contact list has contact information matching with the text, the information of the contact may be found and is used as a search result. For example, assuming that the text is “Zhang San”, if there are contacts “Zhang Sanfeng”, “Zhang San” and the like in the contact list, search results on the contacts may be obtained.

The search engine may be designated by the terminal, or may be any search engine. For example, the search engine may be a search engine already installed in the terminal or a search engine accessed through a browser of the terminal.

In step S405, a search result of the contact list application, a search result of the search engine and a text operating box are displayed on the top layer of the display interface, and the text is displayed in a text displaying region of the text operating box.

The contact information related to the text searched by the contact list application is used as a search result of the contact list application. A search result page may be obtained by searching for the content related to the text through the search engine, and the search result page or a screenshot of the search result page is used as a search result. In this way, the search results of the contact list application and the search engine as well as the text operating box may be displayed on the top layer of the display interface simultaneously.

For example, the search result of the search engine and the search result of the contact list application may be respectively displayed by different display boxes along with the text operating box.

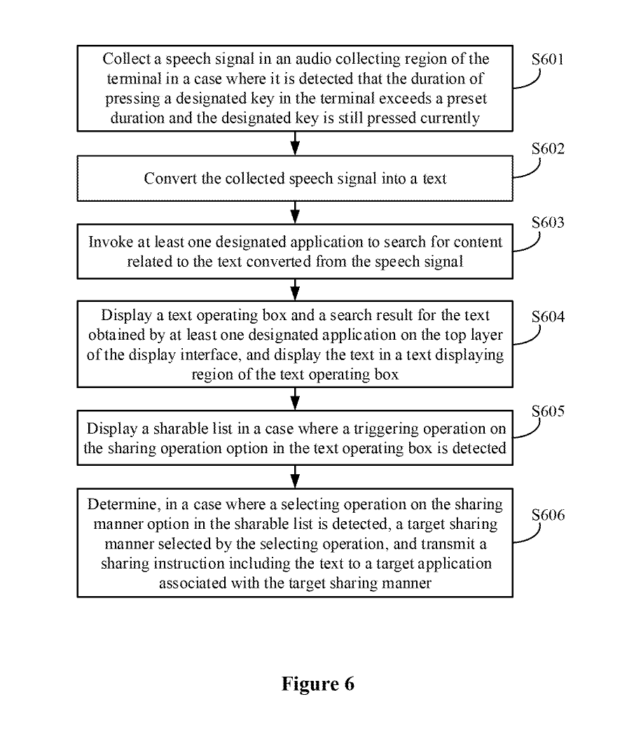

For example, reference may be made to FIG. 5, which is a schematic diagram of a result page for converting a speech signal into a text according to the present disclosure. As can be seen from FIG. 5, the display interface displays not only a text operating box 501 including a text “Zhuxiao”, but also a search result 502 of a contacts obtained by searching for “Zhuxiao” through the contact list application, such as the contact “Zhuxiao*” in FIG. 5. In addition, the display interface also displays a search result 503 obtained by searching for “Zhuxiao” through the search engine. In FIG. 5, different display windows (that is, display boxes) are used to display the found contacts and the search result of the search engine.

In step S406, it is detected whether the number of characters contained in the text in the text operating box is less than a second preset number. If the number of the characters contained in the text in the text operating box is less than the second preset number, step S407 is performed. If the number of the characters contained in the text in the text operating box is not less than the second preset number, step S409 is performed.

The second preset number is greater than the first preset number. For example, the second preset number may be 20.

Similar to step S403, in step S406, it may also be detected or determined whether the total duration for inputting the collected speech signal is less than a second preset duration. The second preset duration is greater than the first preset duration, for example, the second preset duration is 15 seconds. If the total duration for inputting the speech signal corresponding to the text operating box is smaller than the second preset duration, step S407 is performed. If the total duration for inputting the speech signal corresponding to the text operating box is not smaller than the second preset duration, only the text operating box is displayed and the text is displayed in the text operating box.

It should be understood that, if the number of the characters contained in the text is greater than the first preset number, the number of the characters contained in the text is greater than the number of the characters corresponding to a contact in the contact list. In this case, it is less likely for the user to search for a contact based on the text, therefore, it is only necessary to perform step S407 in which the search engine is invoked to search for content related to the text. Correspondingly, if the text contains a large number of characters, it is also less likely for the user to search for the content related to the text through the search engine. In this case, the content related to the text may not be searched for, and only the text operating box is displayed.

In step S407, the search engine in the terminal is invoked to search for the content related to the text in the text operating box.

In step S408, a search result of the search engine and a text operating box is displayed on the top layer of the display interface, and the text is displayed in a text displaying region of the text operating box.

Step S408 is similar to step S405, and step S408 differs from step S405 in that no search result of the contact list application is displayed on the top layer of the display interface in step S408. Taking FIG. 5 as an example, the display interface may include only the text operating box 501 and the search result 503 of the search engine, and does not include the search result 502 of the contact list.

In step S409, the text operating box is displayed on the display interface, and the text is displayed in a text displaying region of the text operating box.

It should be noted that, in this embodiment, the detecting the number of the characters in step S403 and step S406 is only performed in an implementation, the purpose of which is to determine a search manner that required to be activated based on the number of the characters. However, it should be understood that no matter how many characters are contained in the text, the search for the content related to the text may be triggered as needed, and the search result for the text and the text operating box are displayed in the display interface simultaneously. Therefore, in practice, before the operating system of the terminal triggers the search for the content related to the text, the operation of determining a size relationship between the number of the characters and the preset number may not be performed, and one or more designated applications may be directly invoked to search for the content related to the text as needed, and the search results of the applications for the text may be displayed in the display interface.

It should be understood that, in the embodiment, the description is made by taking a case where a designated application in the terminal is invoked to search for the content related to the text as an example. However, it should be understood that the designated application invoked by the terminal is not limited to the above-described contact list application and search engine. In practice, other applications may be invoked to implement the search for the content related to the text.

In addition, in addition to invoking an application to search for the content related to the text, the terminal may search for the content related to the text in a following way that the operating system of the terminal performs searching based on the text. For example, the operating system searches the applications installed in the terminal for a target application with an application name matching with the text; if the target application is found, an icon of the target application is displayed in the display interface, such that the display interface display the text operating box and the icon of the found target application simultaneously. Correspondingly, in a case that it is detected that the icon of the target application displayed in the display interface is clicked, the target application is activated.

For example, assuming that the found target application is an instant messaging application, an icon of the instant messaging application may be displayed in the display interface. If the user clicks the icon of the instant messaging application, the operating system activates the instant messaging application.

However, the search performed by the operating system based on the text is not limited to searching for an application matching with the text in the terminal, and may include other searches based on the text, which is not limited herein.

It should be understood that the text operating box may also have some operation options for triggering some related operations on the text operating box or on the text in the text operating box, for example, the above-described labeling option.

An example where related operations are performed on the text operating box or on the text in the text operating box based on the operation options provided in the text operating box is described hereinafter.

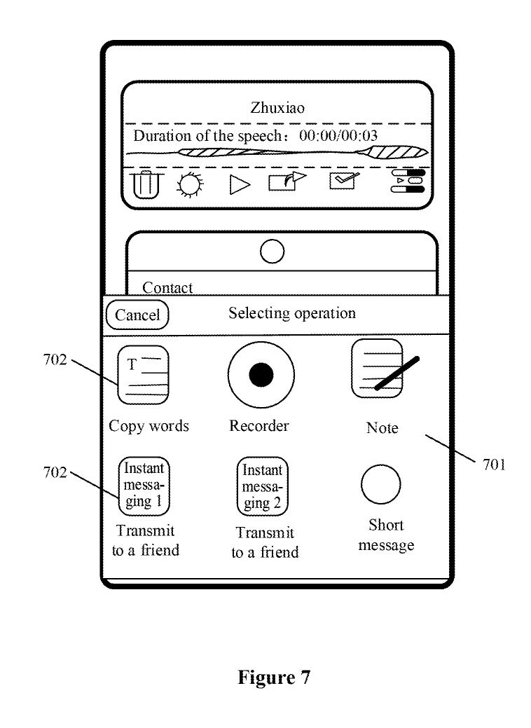

Considering that the user may want to save or share the text in the text operating box to other applications, a sharing operation option for triggering sharing of the text in the text operating box may be provided in the text operating box. The user may trigger a sharing operation by performing a selecting operation such as clicking or touching the sharing operation option. For example, reference is made to FIG. 6, which is a schematic flowchart of a speech processing method according to another embodiment of the present disclosure. The method according to the embodiment may include the following steps S601 to S606.

In step S601, a speech signal in an audio collecting region of the terminal is collected in a case where it is detected that the duration of pressing a designated key in the terminal exceeds a preset duration and the designated key is still pressed currently.

The designated key is capable of being invoked at any interface of the terminal.

In step S602, the collected speech signal is converted into a text.

In step S603, at least one designated application is invoked to search for content related to the text converted from the speech signal.

In the embodiment, step S603 is selectable, and may be performed as needed. In addition, in step S603, a search manner for searching based on the text is described as an example, and other search manners are also applicable to the embodiment. For details, reference may be made to the related description of the embodiment in FIG. 4, and details are not described herein again.

In step S604, a text operating box and a search result for the text obtained by at least one designated application are displayed on the top layer of the display interface, and the text is displayed in a text displaying region of the text operating box.

The text operating box displays a sharing operation option for triggering the sharing of the text in the text operating box.

In step S605, a sharable list is displayed in a case where a triggering operation on the sharing operation option in the text operating box is detected.

The sharable list includes multiple sharing manner options. Each option is used to trigger one sharing manner. For example, the sharing manners may include one or more of: a sharing manner for copying the text into a preset text editing interface, which may be, for example, an editing page for a text document, an editing page for a short message; a sharing manner for saving a speech signal corresponding to the text into a storage region corresponding to a recording application; a sharing manner for backing up the text to a note to use the text as memo information in the note; a sharing manner for transmitting the text to an instant messaging friend; and a sharing manner for sharing the text to a sharing space of an instant messaging application.

However, the above description is merely made by taking the options corresponding to several sharing manners as an example. In practice, more or fewer sharing manners may be provided as needed.

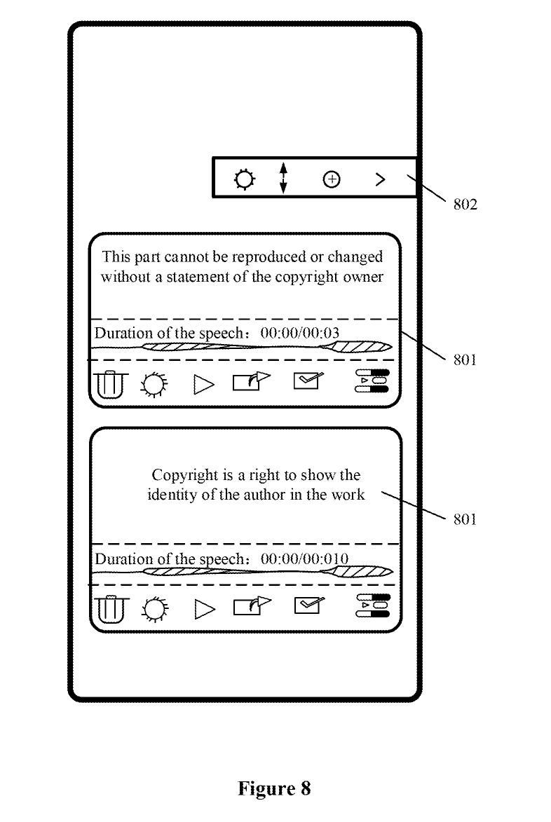

For ease of understanding, reference may be made to FIG. 7, which is a schematic diagram of a sharable list popped up in the display interface after the sharing operation option in the text operating box is clicked. As can be seen from FIG. 7, the sharable list 701 may include multiple sharing manner options 702. For example, the first icon in the first row of the sharable list indicates a sharing manner for copying the text into a text document. For example, the second icon in the second line of the sharable list indicates a sharing manner for transmitting the text to an instant messaging friend.

In step S606, in a case where a selecting operation on the sharing manner option in the sharable list is detected, a target sharing manner selected by the selecting operation is determined, and a sharing instruction including the text is transmitted to a target application associated with the target sharing manner.

The manner of the selecting operation may be set as needed, for example, which may be clicking, pressing or touching a sharing manner option.

For ease of distinction, in the embodiment of the present disclosure, the sharing manner selected by the selecting operation is referred to as a target sharing manner. It should be understood that each sharing manner is associated with an application for implementing the sharing manner. For example, if the sharing manner is used for sharing the text to the sharing space of the instant messaging application, the sharing manner is associated with an instant messaging application. In the embodiment of the present disclosure, an application associated with the target sharing manner is referred to as a target application.

The sharing instruction is configured to instruct the target application to paste, based on the target sharing manner, the text into a region designated by the target sharing manner. For example, taking the sharing manner for sharing the text to the sharing space of the instant messaging application as an example, the operating system of the terminal may transmit a sharing instruction to the instant messaging application to instruct the instant messaging application to paste the text into an editing window for posting a message in the sharing space corresponding to the user of the terminal. For example, taking the sharing manner for transmitting the text to an instant messaging friend as an example, the instant messaging application displays friends selectable by the user in response to the sharing instruction, such that the instant messaging application pastes, after the user selects a friend with whom the user wants to share the text, the text into a message editing window that used to interact with the friend.

In practice, the text operating box is displayed on the display interface. Specifically, if the text operating box is displayed on the top layer of the display interface, the text operating box may affect operation of the user on other applications of the terminal, or viewing of other displayed content in the terminal by the user. In order to enable the user to process the content other than the text operating box, a contraction operation option for triggering contraction of the text operating box may be provided in the text operating box, for example, a contraction operation option 304 displayed below the text operating box as shown in FIG. 3. Correspondingly, the operating system of the terminal hides the text operating box in a case of detecting a trigger operation on the contraction operation option. The triggering operation may be clicking or touching the contraction operation option. A purpose of hiding the text operating box is to make the text operating box not shade other content in the display interface. For example, the text operating box may be hidden by setting the text operating box to enter a background operating state, or setting the text operating box to enter a minimized state.

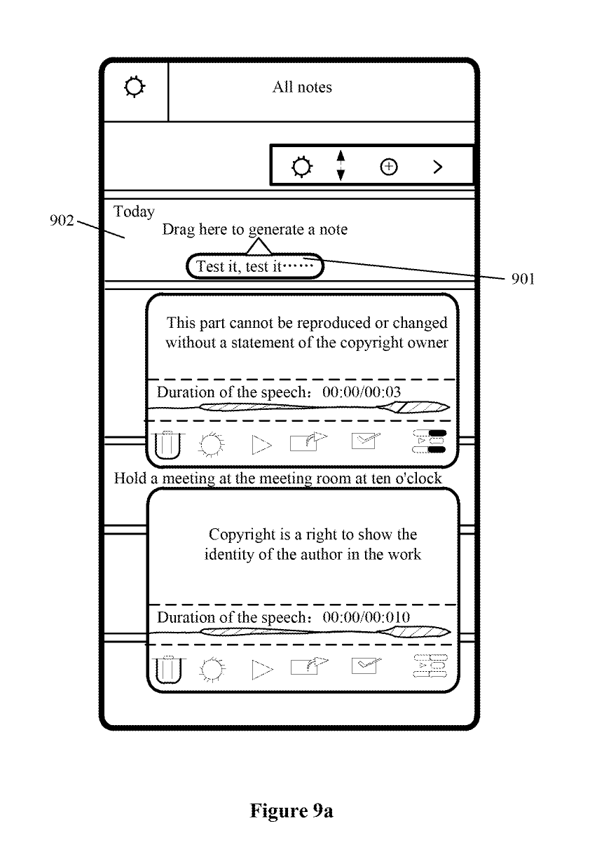

For example, after the contraction operation box 304 in the text operating box in FIG. 3 is touched, the text operation box enters the minimized state, such that a display state 802 of the minimized state of the text operating box is displayed in FIG. 8. It should be understood that, in FIG. 8, in order to show a comparison between the text operating box in a normal displayed state and the contracted text operating box, a case where multiple text operating boxes are displayed in the display interface is described as an example. As can be seen from FIG. 8 that the text operating box at the top of the display interface is in the minimized state, such that the text operating box is displayed as a strip box 802, while the text operating box 801 in the normal displayed state occupies a larger display region.

It should be understood that, each time an operation meeting a preset condition performed on a designated key is detected, a speech signal is collected and the speech signal is converted into a text. However, a different text converted at a different time is displayed in a different text operating box. Therefore, multiple text operating boxes may be displayed in the display interface simultaneously.

It should be noted that, if the search result of the designated application corresponding to the text operating box is displayed while displaying the text operating box, in a case where the triggering operation on the contraction operation option in the text operating box is detected, in addition to that the text operation box is set to enter a hidden state, the search result of the designated application corresponding to the text operating box may also be set to enter the hidden state, or the search result of the designated application may be directly deleted.

Correspondingly, in a case where the text operating box is in the hidden state and an expanding operation option for triggering display of the text operating box is detected, the text operating box is displayed in the display interface or displayed on the top layer of the display interface. As shown in FIG. 8, “>” in the text operating box in the minimized state indicates the expanding operation option. When the icon “>” is clicked, a normal displayed state of the text operating box may be restored on the display interface.

It should be understood that the text operating box may also include a deletion option for triggering deletion of the text operating box, a setting option for triggering related setting on the text operating box and the like, which are not limited herein.

It should be understood that, in the embodiment of the present disclosure, in addition to triggering performing some related processes on the text operating box or on the text in the text operating box by the operation options in the text operating box, the text in the text operating box may be copied to another text editing application that may edit a text by directly dragging the text operating box.

In any of the above embodiments, after the text operating box is displayed, if an operation instruction for activating a text editing application for editing a text is detected, a text editing interface of the text editing application may be displayed, the text editing interface includes at least one text editing region. For example, the text editing application may be a short message application, and the text editing interface may be a short message editing interface which includes a short message editing region, a recipient filling region and the like. Alternatively, the text editing application may be a note application (which is also referred to as a memo application) for recording information, and the text editing interface may be a note generating interface which may include at least one blank note based on which a note is to be generated, information may be inputted to the blank note to generate a note.

In a case where the text operating box is displayed in the display interface, the text operating box may be set to enter a minimized state first, then the text operation interface is activated.

It should be understood that, in practice, if the text editing application is activated and opened before the text operating box is generated, and the text editing interface of the text editing application is displayed on the display interface, in this case, it is unnecessary to open the text editing interface repeatedly.

Correspondingly, in a case where a designated dragging operation on the text operating box is detected, a target text editing region where an ending point of the designated dragging operation is located may be determined from at least one text editing region of the text editing interface, and the text in the text operating box is copied into the target text editing region, such that it is unnecessary for the user to manually input the text to be recorded into the target text editing region.

The designated dragging operation is used to drag the text operating box or the text in the text operating box to the text editing region.

For ease of understanding, the description is made by taking a case where it is required to copy and paste the text in the text operating box into a note to generate a note for the user to record the text as an example.

Assuming that it is required to generate a note for the text “Test it, test it” contained in the text operation box in FIG. 3, after the text operating box is displayed, the user may open a note to present the note application, for example, the note application is set into the minimized state first, then the note application is activated to open a note editing interface of the note application. In the note editing interface, after dragging the text operating box (a text operating box in the minimized state or the normal displayed state) to a blank note in the note application, the operating system transmits the text contained in the text operating box to the note application, and the text is pasted to the blank note by the note application to generate a note containing the text “Test it, test it”, such that the user may generate a memo by simply saving the note without manually inputting the text to the note application.

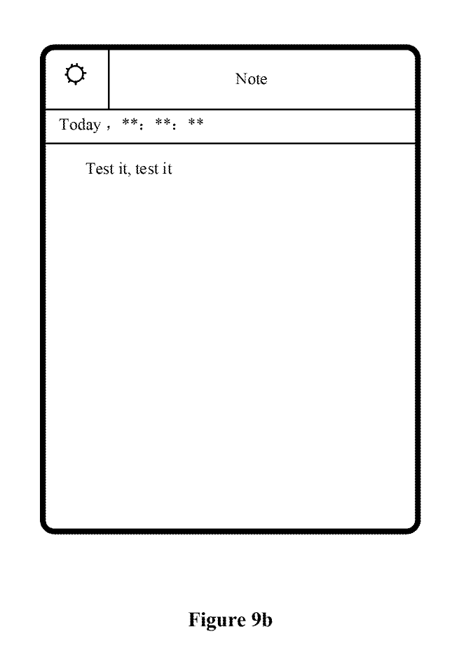

For example, as shown in FIG. 9a, after the text operating box 901 including the text “Test it, test it” is dragged in the note editing page, a prompt information “drag to here, to generate a note” appears in a blank note 902 of the text editing page. In this way, a note to be saved with the text “test it, test it” may be generated by dragging the text operating box to a position of the blank note, as shown in FIG. 9b.

Corresponding to the speech processing method according to the present disclosure, a speech processing device is further provided according to an embodiment of the present disclosure.

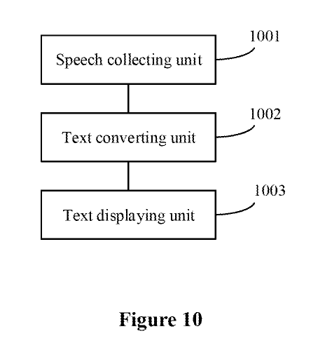

For example, reference is made to FIG. 10, which is a schematic structural diagram of a speech processing device according to an embodiment of the present disclosure. The device according to the embodiment may include a speech collecting unit 1001, a text converting unit 1002 and a text displaying unit 1003.

The speech collecting unit 1001 is configured to collect, in a case where it is detected that an operation on a designated key provided in a terminal meets a preset condition, a speech signal in an audio collecting region of the terminal. The designated key is capable of being invoked at any interface of the terminal.

The text converting unit 1002 is configured to convert the collected speech signal into a text.

The text displaying unit 1003 is configured to display a text operating box on a display interface and display the text in a text displaying region of the text operating box.

In a possible implementation, the device may further include a text searching unit and a search result displaying unit.

The text searching unit is configured to search for content related to the text before the text operating box is displayed on the display interface by the text displaying unit.

The search result displaying unit is configured to display a search result for the text on the display interface while the text operating box is displayed on the display interface by the text displaying unit.

In a possible implementation, the text searching unit includes a first text searching unit. The first text searching unit is configured to invoke at least one designated application in the terminal to search for the content related to the text.

In one embodiment, the first text searching unit may perform one or more of: invoking a search engine in the terminal to search for the content related to the text; and invoking a contact list application in the terminal to search a contact list for the content related to the text.

In another possible implementation, the text searching unit includes a second text searching unit configured to search applications installed in the terminal for a target application with an application name matching with the text.

Correspondingly, the search result displaying unit is configured to display, in a case where the target application is found, an icon of the target application in the display interface while the text operating box is displayed on the display interface by the text displaying unit.

In one embodiment, the device may further include an application activation responding unit configured to activate the target application in a case where it is detected that the icon of the target application displayed in the display interface is clicked after the icon of the target application is displayed in the display interface by the search result displaying unit.

In another possible implementation, a sharing operation option for triggering sharing of the text is further displayed in the text operation box displayed by the text displaying unit.

Correspondingly, the device further includes a list displaying unit and a text sharing unit.

The list displaying unit is configured to display a sharable list in a case where a trigger operation on the sharing operation option is detected after the text is displayed in the text displaying region of the text operating box by the text displaying unit. The sharable list includes multiple sharing manner options.

The text sharing unit is configured to determine, in a case where a selecting operation on a sharing manner option in the sharable list is detected, a target sharing manner selected by the selecting operation, and transmit a sharing instruction containing the text to a target application associated with the target sharing manner. The sharing instruction is configured to instruct the target application to paste, based on the target sharing manner, the text into a region designated by the target sharing manner.

In another possible implementation, the device may further include an editing interface displaying unit and a text pasting unit.

The editing interface displaying unit is configured to display a text editing interface of the text editing application in a case where an operation instruction for activating a text editing application for editing the text is detected after the text is displayed in the text displaying region of the text operating box by the text displaying unit. The text editing interface includes at least one text editing region.

The text pasting unit is configured to determine, in a case where a designated drag operation on the text operating box is detected, a target text editing region where an ending point of the designated drag operation is located from the at least one text editing region of the text editing interface, and copy the text in the text operating box into the target text editing region. The designated drag operation is used to drag the text operating box or the text in the text operating box to the text editing region.

In another possible implementation, a contraction operation option for triggering contraction of the text operating box is further displayed in the text operating box.

The device may further include a text hiding unit and a text restoring unit.

The text hiding unit is configured to hide the text operating box in a case where a trigger operation on the contraction operation option is detected after the text is displayed in the text displaying region of the text operating box by the text displaying unit.

The text restoring unit is configured to display the text operating box in the display interface in a case where a trigger operation on an expanding operation option for triggering display of the text operating box is detected when the text operating box is in a hidden state.

In the above embodiment, the text displaying unit displaying the text operating box on the display interface may include: displaying the text operating box on the top layer of the display interface.

In one embodiment, the designated key is a designated physical key.

The device further includes a state determining unit configured to: determine a current state of the terminal before the speech signal in the audio collecting region of the terminal is collected by the speech collecting unit. In a case where the terminal is in an operating state, the operation for collecting the speech signal in the audio collecting region of the terminal is performed. In a case where the terminal is in a lock screen state or a standby state, the terminal is unlocked or awaked, and the operation for collecting the speech signal in the audio collecting region of the terminal is performed.

The embodiments in this specification are described in a progressive manner, and each embodiment focuses on a difference from other embodiments, and the same or similar parts among the embodiments may be referred to each other. Since the device disclosed in the embodiment corresponds to the method disclosed in the embodiment, the device is described simply, and for the related parts, reference may be made to the description of the method.

The above description of the disclosed embodiments enables those skilled in the art to implement or use the present disclosure. Various modifications to these embodiments are readily apparent to those skilled in the art, and the general principles defined herein may be implemented in other embodiments without departing from the spirit or scope of the disclosure. Therefore, the present disclosure is not limited to the examples shown herein, but should conform to the widest scope consistent with the principles and novel features disclosed herein.

1. A speech processing method for a terminal having a display interface, the speech processing method comprising:
collecting, in a case where it is detected that an operation on a designated key provided in the terminal meets a preset condition, a speech signal in an audio collecting region of the terminal, wherein the designated key is capable of being invoked at any interface of the terminal;
converting the collected speech signal into a text; and
displaying a text operating box on the display interface, and displaying the text in a text displaying region of the text operating box.

2. The speech processing method according to claim 1, wherein
before displaying the text operating box on the display interface, the method further comprises:
searching for content related to the text, and
while displaying the text operating box on the display interface and displaying the text in the text displaying region of the text operating box, the method further comprises:
displaying a search result for the text on the display interface.

3. The speech processing method according to claim 2, wherein the searching for content related to the text comprises:
invoking at least one designated application in the terminal to search for the content related to the text.

4. The speech processing method according to claim 3, wherein the invoking at least one designated application to search for the content related to the text comprises one or more of:
invoking a search engine in the terminal to search for the content related to the text; and
invoking a contact list application in the terminal to search a contact list for the content related to the text.

5. The speech processing method according to claim 2, wherein
the searching for content related to the text comprises:
searching applications installed in the terminal for a target application with an application name matching with the text, and
the displaying a search result for the text on the display interface comprises:
displaying, in a case where the target application is found, an icon of the target application in the display interface.

6. The speech processing method according to claim 5, wherein after displaying the icon of the target application in the display interface, the method further comprises:
activating the target application in a case where it is detected that the icon of the target application displayed in the display interface is clicked.

7. The speech processing method according to claim 1, wherein
a sharing operation option for triggering sharing of the text is further displayed in the text operating box,
after displaying the text in the text displaying region of the text operating box, the method further comprises:
displaying a sharable list in a case where a triggering operation on the sharing operation option is detected, wherein the sharable list comprises a plurality of sharing manner options; and
determining, in a case where a selecting operation on an sharing manner option in the sharable list is detected, a target sharing manner selected by the selecting operation, and transmitting a sharing instruction containing the text to a target application associated with the target sharing manner, wherein the sharing instruction is configured to instruct the target application to paste, based on the target sharing manner, the text into a region designated by the target sharing manner.

8. The speech processing method according to claim 1, wherein after displaying the text in the text displaying region of the text operating box, the method further comprises:
displaying, in a case where an operation instruction for activating a text editing application for editing a text is detected, a text editing interface of the text editing application, wherein the text editing interface comprises at least one text editing region; and
determining, in a case where a designated drag operation on the text operating box is detected, a target text editing region where an ending point of the designated drag operation is located from the at least one text editing region of the text editing interface, and copying the text in the text operating box into the target text editing region, wherein the designated drag operation is used to drag the text operating box or the text in the text operating box to the text editing region.

9. The speech processing method according to claim 1, wherein
a contraction operation option for triggering contraction of the text operating box is further displayed in the text operating box, and
after displaying the text in the text displaying region of the text operating box, the method further comprises:
hiding the text operating box in a case where a trigger operation on the contraction operation option is detected; and
displaying, in a case where a trigger operation on an expanding operation option for triggering display of the text operating box is detected when the text operating box is in a hidden state, the text operating box in the display interface.

10. The speech processing method according to claim 1, wherein the displaying the text operating box on the display interface comprises:
displaying the text operating box on a top layer of the display interface.

11. The speech processing method according to claim 1, wherein the designated key is a designated physical key, before collecting the speech signal in the audio collecting region of the terminal, the method further comprises:
determining a current state of the terminal; wherein
in a case where the terminal is in an operating state, the operation for collecting the speech signal in the audio collecting region of the terminal is performed; and
in a case where the terminal is in a lock screen state or a standby state, the terminal is unlocked or awaked, and the operation for collecting the speech signal in the audio collecting region of the terminal is performed.

12. A speech processing device, comprising:
a speech collecting unit configured to collect, in a case where it is detected that an operation on a designated key provided in a terminal meets a preset condition, a speech signal in an audio collecting region of the terminal, wherein the designated key is capable of being invoked at any interface of the terminal;
a text converting unit configured to convert the collected speech signal into a text; and
a text displaying unit configured to display a text operating box on a display interface and display the text in a text displaying region of the text operating box.

13. The speech processing device according to claim 12, further comprising:
a text searching unit configured to search for content related to the text before the text operating box is displayed on the display interface by the text displaying unit; and
a search result displaying unit configured to display a search result for the text on the display interface while the text operating box is displayed on the display interface by the text displaying unit.

14. The speech processing device according to claim 13, wherein the text searching unit comprises:
a first text searching unit configured to invoke at least one designated application in the terminal to search for the content related to the text.

15. The speech processing device according to claim 13, wherein the text searching unit comprises:
a second text searching unit configured to search applications installed in the terminal for a target application with an application name matching with the text, wherein
the search result displaying unit is configured to display, in a case where the target application is found, an icon of the target application in the display interface while the text operating box is displayed on the display interface by the text displaying unit.

16. The speech processing device according to claim 12, wherein a sharing operation option for triggering sharing of the text is further displayed in the text operating box displayed by the text displaying unit,
the speech processing device further comprises:
a list displaying unit configured to display a sharable list in a case where a triggering operation on the sharing operation option is detected after the text is displayed in the text displaying region of the text operating box by the text displaying unit, wherein the sharable list comprises a plurality of sharing manner options; and
a text sharing unit configured to determine, in a case where a selecting operation on an sharing manner option in the sharable list is detected, a target sharing manner selected by the selecting operation, and transmit a sharing instruction containing the text to a target application associated with the target sharing manner, wherein the sharing instruction is configured to instruct the target application to paste, based on the target sharing manner, the text into a region designated by the target sharing manner.

17. The speech processing device according to claim 12, further comprising:
an editing interface displaying unit configured to display, in a case where an operation instruction for activating a text editing application for editing a text is detected after the text is displayed in the text displaying region of the text operating box by the text displaying unit, a text editing interface of the text editing application, wherein the text editing interface comprises at least one text editing region; and
a text pasting unit configured to determine, in a case where a designated drag operation on the text operating box is detected, a target text editing region where an ending point of the designated drag operation is located from the at least one text editing region of the text editing interface, and copy the text in the text operating box into the target text editing region, wherein the designated drag operation is used to drag the text operating box or the text in the text operating box to the text editing region.

18. The speech processing device according to claim 12, wherein
a contraction operation option for triggering contraction of the text operating box is further displayed in the text operating box, and
the speech processing device further comprises:
a text hiding unit configured to hide the text operating box in a case where a trigger operation on the contraction operation option is detected after the text is displayed in the text displaying region of the text operating box by the text displaying unit; and
a text restoring unit configured to display the text operating box in the display interface in a case where a trigger operation on an expanding operation option for triggering display of the text operating box is detected when the text operating box is in a hidden state.

19. The speech processing device according to claim 12, wherein the text displaying unit is configured to display the text operating box on a top layer of the display interface.

20. The speech processing device according to claim 12, wherein
the designated key is a designated physical key, and
the speech processing device further comprises a state determining unit configured to determine a current state of the terminal before the speech signal in the audio collecting region of the terminal is collected by the speech collecting unit, wherein
in a case where the terminal is in an operating state, the operation for collecting the speech signal in the audio collecting region of the terminal is performed, and
in a case where the terminal is in a lock screen state or a standby state, the terminal is unlocked or awaked, and the operation for collecting the speech signal in the audio collecting region of the terminal is performed.
